(19) United States
(12) Patent Application Publication
(10) Pub. No.: US 2010/0036727 A1
(43) Pub. Date: Feb. 11, 2010

(54) Method of Tracking the Impact of Paid Search on Offline Sales

(76) Inventors: Seth H. Sarelson, New York, NY (US); Johnathan A. Treiber, New York, NY (US); Gregory Hansen, Twp. of Washington, NJ (US)

Correspondence Address: HEDMAN & COSTIGAN P.C., 1185 AVENUE OF THE AMERICAS, NEW YORK, NY, 10036, US

(21) Appl. No.: 12/506,463

(22) Filed: Jul. 21, 2009

Related U.S. Application Data
(60) Provisional application No. 61/086,876, filed on Aug. 7, 2008.

(51) Int. Cl. G06Q 30/00; G06F 17/30

(52) U.S. Cl. 705/14.45; 705/14.69; 707/5; 707/E17.109

(57) ABSTRACT

A method whereby internet search keyword(s) can be associated with a purchase at an offline merchant. The process empowers the merchant to optimize bids to invest more money in keyword(s) with a stronger return on investment and less money in keyword(s) with a lower return on investment.

### FIELD OF THE INVENTION

The invention relates to the field of sales and marketing. More particularly, the invention relates to search engine marketing.

### BACKGROUND OF THE INVENTION

Traditional search engine marketing networks (“SEMN”) such as GOOGLE™ ADWORDS™, MICROSOFT® ADCENTER™, and YAHOO!® SPONSORED SEARCH™, match merchants seeking search engine marketing services with consumers searching on related content. The merchants bid on keyword(s) that are relevant to the products or services that they offer and typically pay the SEMN for each click that results from an advertisement. These SEMNs drive the consumer to the merchant's webpage, where the consumer may make an online purchase or engage in research regarding a product or service.

Most SEMNs offer a web-based interface that integrates with the merchant's website to measure vital performance metrics such as visits, pageviews, pages/visit, bounce rate, avg. time on Site, new visits, sales, and search keyword(s). One of the most critical elements of all performance metrics is the ability to measure search keyword(s) against online sales. The ability to associate each keyword(s) with an online sale empowers the merchant to optimize bids to invest more money in keyword(s) with a stronger return on investment and less money in keyword(s) with a lower return on investment.

Many consumers, however, search online and shop offline. Offline merchants are defined in this document as merchant locations that are non-internet based. This includes both merchants that provide at least one physical location at which a consumer can shop (e.g., a retail storefront) and merchants that do not provide a storefront (e.g., mail order and telephone order catalogues). A merchant can be both online and offline, but the term “offline merchant” is directed to either that segment of a merchant's business that is conducted at a non-internet based location (such as a brick-and-mortar store) or to a merchant that conducts all its business at a non-internet based location.

When consumers search online and shop offline, these sales cannot currently be associated with search keyword(s). There is, at present, no process to track and attribute an offline sale to the online search keyword(s) that drove that sale.

For these and other reasons, it is desirable to provide a process that can track and attribute online search keyword(s) to a purchase with an offline merchant.

### SUMMARY OF THE INVENTION

It is therefore an object of the present invention to provide a method whereby search keyword(s) can be associated with a purchase at an offline merchant.

Note that in this invention, the term “tracking code” includes, but is not limited to any type of numeric code, alphanumeric code, barcode, identification device, or other method that facilitates identification of search keyword(s). Further, the term “qualifying transaction” is defined as any action that is associated with a unique tracking code.

Accordingly, these objects and others not particularly set forth above are achieved by the method and system of the present invention which comprises the steps of a merchant creating a paid search ad with keyword(s) insertion in the destination URL, a consumer performing an online search, applying a unique promotional code, barcode, or other tracking code (collectively, “unique promotional code”) to the search keyword(s); delivering advertisements embedded with the unique promotional code to consumers; accepting the unique promotional code at registered merchants for the purchase of goods and/or services or any other action desired by a registered merchant; tracking the unique promotional code and association with the consumer's purchase of goods and/or services or other desired action.

In a preferred embodiment, the invention can also include the step of clicking on a paid search listing.

An additional embodiment also includes the step of applying this unique promotional code to a consumer or other user in addition to the search keyword(s).

An additional embodiment also includes the step of applying a code that identifies the value of the promotion, instructions to include or exclude certain product(s) or service(s), an expiration date, or any other relevant information.

An additional embodiment also includes the step of transforming the unique promotional code into another identifiable form, including, but not limited to, barcodes, RFID tags, phone numbers, numeric codes, alphanumeric codes, images, and other methods of data storage.

An additional embodiment also includes the step of reporting qualifying transactions and associated unique promotional codes to the SEMN.

An additional embodiment also includes the step of charging a registered merchant a marketing fee when a unique promotional code has been used for a consumer's qualifying transaction.

The present invention provides a solution to the problem that there is currently no process to track and attribute an offline sale to the online search keyword(s) that drove that sale.

A summary of the preferred steps of the method of tracking the impact of paid search on offline sales is as follows:
a. creating a merchant's paid search ad with keyword(s) insertion in the destination URL;
b. performing of a search by a consumer;
c. applying a unique promotional code, barcode, or other tracking code to the search keyword(s);
d. delivering advertisements embedded with the unique promotional code to consumers;
e. accepting said unique promotional code at registered merchants for the purchase of goods and/or services or any other desired action by a registered merchant;
f. tracking of the unique promotional code at the registered merchant and association with the consumer's purchase of goods and/or services or other desired action;

In a preferred embodiment, the invention can also include the step of clicking on a paid search listing. This step of clicking on a paid search listing can be performed by several different entities including, but not limited to the consumer.

An additional embodiment also includes the step of applying this unique promotional code to a consumer or other user in addition to the search keyword(s). This step of applying this unique promotional code to a consumer or other user in addition to the search keyword(s) can be performed by several different entities including, but not limited to the merchant, SEMNs, media companies, paid search advertising agencies, search affiliates, affiliate sales networks, marketers, and combinations thereof.

An additional embodiment also includes the step of applying a code that identifies the value of the promotion, instructions to include or exclude certain product(s) or service(s), an expiration date, or any other relevant information. This step of applying a code that identifies the value of the promotion, instructions to include or exclude certain product(s) or service(s), an expiration date, or any other relevant information can be performed by several different entities including, but not limited to the merchant, SEMNs, media companies, paid search advertising agencies, search affiliates, affiliate sales networks, marketers, and combinations thereof.

An additional embodiment also includes the step of transforming the unique promotional code into another identifiable form, including, but not limited to, barcodes, RFID tags, phone numbers, numeric codes, alphanumeric codes, images, and other methods of data storage. The step of transforming the unique promotional code into another identifiable form can be performed by several different entities including, but not limited to the merchant, SEMNs, media companies, paid search advertising agencies, search affiliates, affiliate sales networks, marketers, and combinations thereof.

An additional embodiment also includes the step of reporting qualifying transactions and associated unique promotional codes to the SEMN. The step of reporting qualifying transactions and associated unique promotional codes be performed by several different entities including, but not limited to the merchant, SEMNs, media companies, paid search advertising agencies, search affiliates, affiliate sales networks, marketers, and combinations thereof.

An additional embodiment also includes the step of charging a registered merchant a marketing fee when a unique promotional code has been used for a consumer's qualifying transaction. The step of charging a registered merchant a marketing fee be performed by several different entities including, but not limited to the merchant, SEMNs, media companies, paid search advertising agencies, search affiliates, affiliate sales networks, marketers, and combinations thereof.

The term “merchant” includes, but is not limited to, offline merchants, online merchants and merchants with both an online and offline presence.

The term “search affiliates” includes, but is not limited to, marketers that utilize pay per click search engines to promote advertisers.

The term “affiliate sales network” includes, but is not limited to, an entity that matches merchants seeking pay-per-action marketing with internet publishers seeking to earn commissions by promoting a merchant's products and/or services.

The step of creating a merchant's paid search ad with keyword(s) insertion in the destination URL can be performed by several different entities including, but not limited to the merchant, SEMNs, media companies, paid search advertising agencies, search affiliates, affiliate sales networks, marketers, and combinations thereof.

The step of performing of a search by a consumer can be performed by several different entities including, but not limited to the consumer.

The step of applying a unique promotional code, barcode, or other tracking code to the search keyword(s) can be performed by several different entities including, but not limited to the merchant, SEMNs, media companies, paid search advertising agencies, search affiliates, affiliate sales networks, marketers, and combinations thereof.

The step of delivering advertisements to consumers can be performed by several different entities including, but not limited to rewards/loyalty programs, magazines, newspapers, printers, television networks, radio stations, web portals, blogs, search engines, internet websites, intranet websites, email marketers, video games, marketers, SEMNs, financial institutions, banks, payments processors, mobile media companies, payment vehicle associations, affinity organizations, payment card issuers, merchants, media companies, and combinations thereof.

The consumer can include, but is not limited to, an individual, a group, an organization, a business, a private entity, a commercial entity, a government entity and combinations thereof.

The advertisements can include, but are not limited to, mail, email, SMS messages, MMS message, GPS advertisements, interactive voice responses, magazines, newspapers, mobile media, direct mail ads, shared mail ads, billboards, signs, movie ads, television ads, radio ads, web portals, blogs, search engines, internet website ads, banner ads, popup ads, intranet websites, video games, podcasts, printed coupons, printable coupons, and any other type of print or interactive media and combinations thereof.

The step of accepting the unique promotional code at registered merchant for the purchase of goods and/or services or any other action desired by a merchant can be performed by several different entities including, but not limited to, merchants, marketers, SEMNs, financial institutions, banks, payment processors, payment vehicle associations, affinity organizations, payment card issuers, media companies, and combinations thereof.

The step of tracking the unique promotional code at registered merchant for the purchase of goods and/or services or any other action desired by a merchant can be performed by several different entities including, but not limited to, merchants, marketers, SEMNs, financial institutions, banks, payment processors, payment vehicle associations, affinity organizations, payment card issuers, media companies, and combinations thereof.

It is envisioned that other modifications can be made to the invention.

### BRIEF DESCRIPTION OF THE DRAWINGS

The attached drawings are intended to better illustrate the present invention without limiting it in any manner whatsoever.

FIG. 1 is a schematic diagram illustrating a preferred embodiment of the present invention.

FIG. 2 is a schematic diagram illustrating a preferred embodiment of the creation of a unique promotional code.

### DETAILED DESCRIPTION OF THE PRESENT INVENTION

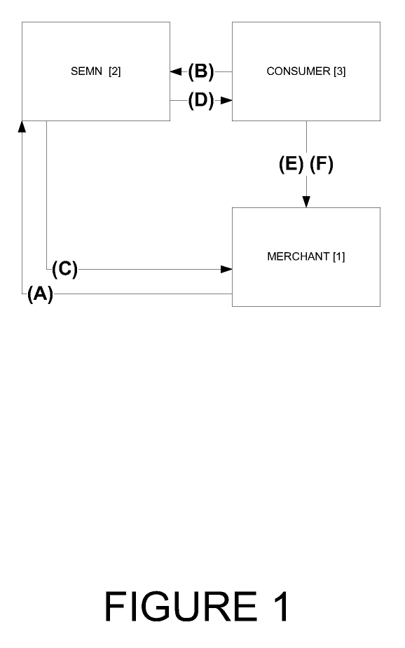

The following description is presented to describe the preferred embodiments of the present invention without limiting the scope of the appended claims. In FIG. 1, letters are used to designate steps while numbers are used to designate entities. In some cases, multiple steps are shown along a single path in order to clarify the diagram. This is not to be construed as being the same step designated in different ways. Rather, it is to be construed as different steps.

As best shown in FIG. 1, a merchant (1) creates (A) a paid search ad with the SEMN (2), utilizing keyword(s) insertion in the destination URL. A consumer (3) searches (B) with the SEMN (2). A merchant (1) retrieves the search keyword(s) from the destination URL and applies (C) a unique promotional code, barcode, or other tracking code to the search keyword(s).

The SEMN (2) delivers an advertisement (D) embedded with the unique promotional code. This unique promotional code can be delivered in the form of a barcode or promotional code on a coupon or other advertising vehicle via RFID tags, phone numbers, alphanumeric codes, images, and other methods of data storage.

When the consumer (3) makes a purchase or other desired action (E), the merchant (1) associates (F) the unique promotional code with the consumer's (3) purchase or other desired action.

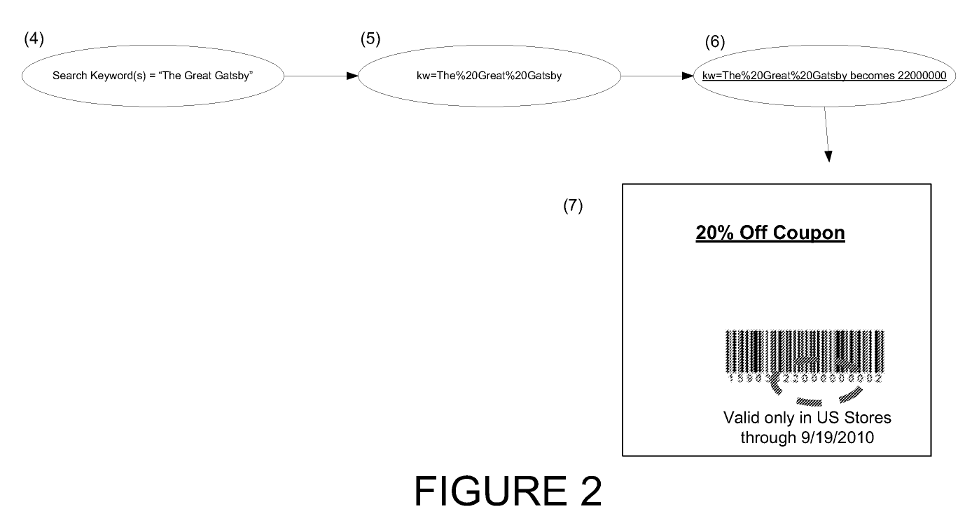

FIG. 2 depicts the creation of a resulting promotional code. A consumer searches on the keyword(s) (4) (“The Great Gatsby” in FIG. 2) with the SEMN. The merchant uses keyword(s) insertion into the destination URL(5). The merchant then retrieves the search keyword(s) from the destination URL (5) and applies a unique promotional code (6) to the search keyword(s). The merchant then delivers an advertisement embedded with the unique promotional code (7). The merchant may then associate the promotional code with the consumer's purchase of goods and/or services or other desired action.

Variations, modifications and changes to the preferred methods described above will be apparent to those skilled in the art. All such variations, modifications and changes are intended to fall within the spirit and scope of the present invention, limited solely by the appended claims.

1. A method of tracking the impact of paid search on offline sales comprising the steps of:
a. creating a merchant's paid search ad with keyword(s) insertion in the destination URL;
b. performing of a search by a consumer;
c. applying a unique promotional code, barcode, or other tracking code to the search keyword(s);
d. delivering advertisements embedded with the unique promotional code to consumers;
e. accepting said unique promotional code at registered merchants for the purchase of goods and/or services or any other desired action by a registered merchant;
f. tracking of the unique promotional code at the registered merchant and association with the consumer's purchase of goods and/or services or other desired action;

2. The method of claim 1, wherein the step of creating a merchant's paid search ad with keyword(s) insertion in the destination URL can be performed by several different entities including, but not limited to the merchant, SEMNs, media companies, paid search advertising agencies, search affiliates, affiliate sales networks, marketers, and combinations thereof.

3. The method of claim 1, wherein the step of performing of a search by a consumer can be performed by several different entities including, but not limited to the consumer.

4. The method of claim 1, wherein said consumer is taken from the group consisting of an individual, a group, an organization, a business, a private entity, a commercial entity, a government entity and combinations thereof.

5. The method of claim 1, wherein the step of applying a unique promotional code, barcode, or other tracking code to the search keyword(s) can be performed by several different entities including, but not limited to the merchant, SEMNs, media companies, paid search advertising agencies, search affiliates, affiliate sales networks, marketers, and combinations thereof.

6. The method of claim 1, wherein the step of delivering advertisements to consumers can be performed by several different entities including, but not limited to rewards/loyalty programs, magazines, newspapers, printers, television networks, radio stations, web portals, blogs, search engines, internet websites, intranet websites, email marketers, video games, marketers, SEMNs, financial institutions, banks, payments processors, mobile media companies, payment vehicle associations, affinity organizations, payment card issuers, merchants, media companies, and combinations thereof.

7. The method of claim 1, wherein said advertisement is taken from the group consisting of mail, email, SMS messages, MMS message, GPS advertisements, interactive voice responses, magazines, newspapers, mobile media, direct mail ads, shared mail ads, billboards, signs, movie ads, television ads, radio ads, web portals, blogs, search engines, internet website ads, banner ads, popup ads, intranet websites, video games, podcasts, printed coupons, printable coupons, and any other type of print or interactive media and combinations thereof.

8. The method of claim 1 wherein the step of accepting the unique promotional code at registered merchant for the purchase of goods and/or services or any other action desired by a merchant can be performed by several different entities including, but not limited to, merchants, marketers, SEMNs, financial institutions, banks, payment processors, payment vehicle associations, affinity organizations, payment card issuers, media companies, and combinations thereof.

9. The method of claim 1 wherein the step of tracking the unique promotional code at registered merchant for the purchase of goods and/or services or any other action desired by a merchant can be performed by several different entities including, but not limited to, merchants, marketers, SEMNs, financial institutions, banks, payment processors, payment vehicle associations, affinity organizations, payment card issuers, media companies, and combinations thereof.

10. The method of claim 1, further comprising the step of clicking on a paid search listing.

11. The method of claim 10, wherein the step of clicking on a paid search listing can be performed with direct involvement from one or more of several different entities including, but not limited to the consumer.

12. The method of claim 1, further comprising the step of applying this unique promotional code to a consumer or other user in addition to the search keyword(s).

13. The method of claim 12, wherein the step of applying this unique promotional code to a consumer or other user in addition to the search keyword(s) can be performed with direct involvement from one or more of several different entities including, but not limited to the merchant, SEMNs, media companies, paid search advertising agencies, search affiliates, affiliate sales networks, marketers, and combinations thereof.

14. The method of claim 1, further comprising the step of applying a code that identifies the value of the promotion, instructions to include or exclude certain product(s) or service(s), an expiration date, or any other relevant information.

15. The method of claim 14, wherein the step of applying a code that identifies the value of the promotion, instructions to include or exclude certain product(s) or service(s), an expiration date, or any other relevant information can be performed with direct involvement from one or more of several different entities including, but not limited to the merchant, SEMNs, media companies, paid search advertising agencies, search affiliates, affiliate sales networks, marketers, and combinations thereof.

16. The method of claim 1, further comprising the step of transforming the unique promotional code into another identifiable form, including, but not limited to, barcodes, RFID tags, phone numbers, numeric codes, alphanumeric codes, images, and other methods of data storage.

17. The method of claim 16, wherein the step of transforming the unique promotional code into another identifiable form can be performed with direct involvement from one or more of several different entities including, but not limited to the merchant, SEMNs, media companies, paid search advertising agencies, search affiliates, affiliate sales networks, marketers, and combinations thereof.

18. The method of claim 1, further comprising the step of reporting qualifying transactions and associated unique promotional codes to the SEMN.

19. The method of claim 18, wherein the step of reporting qualifying transactions and associated unique promotional codes be performed with direct involvement from one or more of several different entities including, but not limited to the merchant, SEMNs, media companies, paid search advertising agencies, search affiliates, affiliate sales networks, marketers, and combinations thereof.

20. The method of claim 1, further comprising the step of charging a registered merchant a marketing fee when a unique promotional code has been used for a consumer's qualifying transaction.

21. The method of claim 20, wherein the step of charging a registered merchant a marketing fee be performed with direct involvement from one or more of several different entities including, but not limited to the merchant, SEMNs, media companies, paid search advertising agencies, search affiliates, affiliate sales networks, marketers, and combinations thereof.
